(19) United States
(12) Patent Application Publication
(10) Pub. No.: US 2020/0308489 A1
(43) Pub. Date: Oct. 1, 2020

(54) FIRE-RETARDING MIXTURE WITH CARBONACEOUS COMPONENT AND PROCESS FOR THE PRODUCTION THEREOF

(71) Applicant: PROSETEX S.P.A.

(72) Inventors: DAVIDE COLOMBO, BULCIAGO (IT); LUCA MAGAGNIN, BULCIAGO (IT); ALESSANDRA ACCOGLI, BULCIAGO (IT); EUGENIO GIBERTINI, BULCIAGO (IT)

(21) Appl. No.: 16/328,024

(22) PCT Filed: Aug. 28, 2017
(86) PCT No.: PCT/IB2017/055156

§ 371 Date: Feb. 25, 2019

(30) Foreign Application Priority Data
Aug. 30, 2016 (IT) 102016000088008

(51) Int. Cl. C09K 21/04; C08K 3/22; C08K 3/32; C08K 3/016; C08K 3/04; C09K 21/14; C08K 7/24; D06M 15/233; D06M 11/74; D06M 11/71; D06M 15/693

(52) U.S. Cl. CPC C09K 21/04; C08K 3/22; C08K 3/32; C08K 3/016; C08K 3/041; C08K 3/042; B82Y 30/00; C08K 7/24; D06M 15/233; D06M 11/74; D06M 11/71; D06M 15/693; C09K 21/14

(57) ABSTRACT

A fire-retarding mixture made of an aqueous solution of a base reagent consisting of an ammonium phosphate compound and a carbonaceous component dispersed in the aqueous solution.

The present invention relates to a fire-retarding mixture with a carbonaceous component, a process for the production thereof, a fabric treated with this mixture and a method for treating the fabric.

It is known in the technical sector of fabrics, in particular where the fabrics are used as a lining or covering, that the same are required by regulations to be fire-proof in order to ensure the safety of end users.

It is also known that all textile products are inflammable and respond to the application of a flame in a completely different manner depending on the chemical nature of the fibres (cotton, nylon, propylene, viscose), their orientation inside the article, the physical dimensions and the end application.

Depending on the dimensions of the textile product, the fire-behaviour is completely different: the lower the ratio between mass and surface area of the material, the easier and the faster it will burn. The combustion of the fabric is also influenced by its structure which determines the accessibility of oxygen/air, combustion agent of the combustion reaction.

The end application of the fabric influences significantly the fire-behaviour: in the case of fabrics used for furnishing, such as curtains and hung materials, the reaction is extremely critical, due to the heat flow which spreads upwards, to the double exposure to the combustion agent (air/oxygen) and transportation of the flames which is facilitated.

In the sector of the textile industry, the fire-proofing treatment of fabrics is based mainly on a process of back-coating with polymer resins which are subject to different phases during the combustion process.

In the case of polymer materials, combustion may be defined as being a catalytic exothermic reaction which is self-fuelling following the generation of free radicals, principally the species H. and OH., and radiant heat. The flame is an exothermic combustion in the gaseous phase and the heat generated increases the thermal degradation of the polymeric material in the solid phase, causing the further emission of combustible vapours. The cycle is therefore self-fuelling and self-accelerating until the material has been completely burned.

Owing to their organic nature, it is not possible to develop polymers which do not burn: only the use of specific additives, known as flame-retardants, allows the combustibility and the speed of propagation of the flame to be reduced, resulting in some cases in a behaviour which is referred to as being “self-extinguishing”.

Flame-retardants are therefore chemical species which are designed to improve the fire-reaction of polymer materials. Their main function is to reduce the speed of heat transfer to the polymer so as to prevent the thermal degradation process thereof, with the consequent formation of radical species which, being free, interrupt the self-fuelling cycle.

The method currently preferred for providing the polymer with a flame-retarding behaviour consists in adding to the polymer resin retarding additives of a varying nature. From this point of view, the fire-resistance in the case of polymers may, in general, be improved principally by adopting three different strategies:
acting in the vapour phase: adding flame retardants which interact with the combustion reaction in the vapour phase,
acting in the condensed phase: adding flame retardants which prevent the degradation of the polymer and the diffusion of heat with the formation of combustion products;
adding flame retardants which facilitate the dispersion of the heat from the polymer, limiting the thermal degradation thereof and all the processes associated with it.

Currently the desired characteristics in terms of flame resistance are achieved by means of processes involving coating the back of the fabric with polymer resins to which antimony trioxide (Sb₂O₃) have been added, along with halogenated additives.

The toxicity and the environmental impact associated with antimony trioxide (Sb₂O₃) are such, however, that the use of this chemical substance must be restricted.

Further examples of the prior art are described in: US 2005/287894 A1, which describes a coating for a textile comprising a polymeric binder such as a latex acrylic co-polymeric emulsion and a flame retardant composition intermixed with the polymeric binder as well as a dispersant and/or thickener suitable for achieving the desired characteristics of the coating. The flame retardant composition preferably includes an acid donor such as ammonium polyphosphate, mono-ammonium phosphate, diammonium phosphate, potassium tripolyphosphate or combinations thereof; a carbonaceous component such as dipentaerythritol (DPE), pentaerythritol, polyols, chlorinated paraffin, or a combination thereof; and a blowing agent such as melamine, urea, dicyandiamide or a combination thereof.

Fillers and pigments such as titanium dioxide, zinc oxide, silicates, carbon black, calcium carbonate and the like may also be added.

U.S. Pat. No. 9,097,011 81, which describes a heat and flame resistant system, comprising a foam substrate and at least one layer of an intumescent coating applied onto a surface of the foam substrate The intumescent coating includes an intumescent catalyst, a carbonific, a blowing agent, expandable graphite, and a binder. According to another aspect, the layer of intumescent coating comprises ammonium polyphosphate, a polyhydric alcohol, melamine, expanded graphite, and a latex binder.

EP 1 842 957 A1, which describes a fibre sheet containing an polyammonium phosphate whose average degree of polymerization is in the range of between 10 and 40, and an expandable graphite.

JP 2005 290363 A, which describes a composition for delaying combustion, comprising polyphosphoric acid and expandable graphite.

A technical problem which the invention intends solving is that of providing fire-retarding products which are an alternative to those of the prior art and are particularly suitable for the treatment of surfaces such as those of a fabric and which are preferably characterized by optimum flame-retarding properties, a low toxicity and easy disposability.

For the purposes of the present patent the term “fire-retarding” will be used to characterize a mixture which is able to make a material, in particular a fabric, fire-resistant or limit the spreading of combustion thereof.

In connection with this problem it is also requested that these products should be easy and low-cost to produce and be able to be applied to the fabrics using normal standardized processes.

These results are obtained according to the present invention by a fire-retarding mixture according to the characteristic features of claim 1 or 9.

Starting from the aforementioned needs, the Applicant has in fact surprisingly found that that, by mixing an aqueous solution of an ammonium phosphate compound with one or more selected carbonaceous components, it is possible to obtain effective fire-retarding products, in particular suitable for treating a surface such as that of a fabric.

The present invention relates furthermore to a process for the production of a mixture of the invention according to the features of claim 18, and a fabric treated with a mixture of the invention according to the features of claim 23.

The present invention also relates to a method for treating a surface, in particular of a fabric, in which a mixture of the invention is applied to the surface so as to form a fire-retarding layer.

Further details may be obtained from the following description of non-limiting examples of embodiment of the subject matter of the present invention, provided with reference to the accompanying drawings, in which:

FIGS. 1a,1b: show a view of a seat lined with untreated fabric and exposed to the action of a free flame, when lit and when extinguished, respectively;

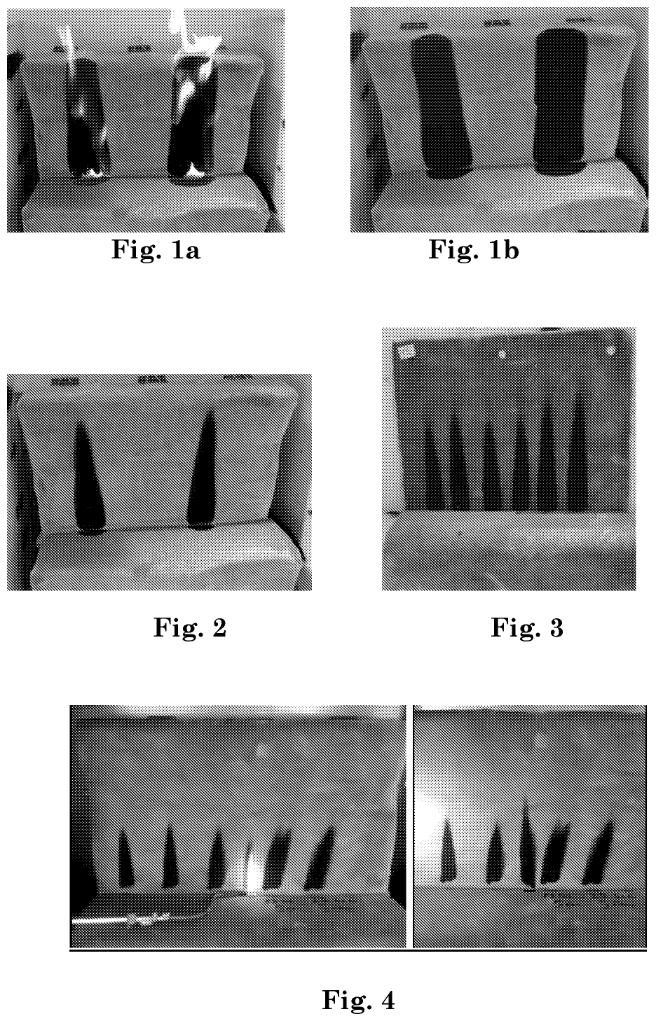

FIG. 2: shows a view of a seat with fabric which has been treated with a fire-retarding mixture according to the invention at the end of a test where a free flame is applied to two points of the seat;

FIG. 3: shows a view of a seat which is lined with fabric treated with a fire-retarding mixture according to the present invention containing a polymeric dispersion additive, at the end of six tests were a free flame is applied;

FIG. 4: shows a view of a seat lined with fabric which has been treated with a fire-retarding mixture according to Example 4 following a flame-resistance test;

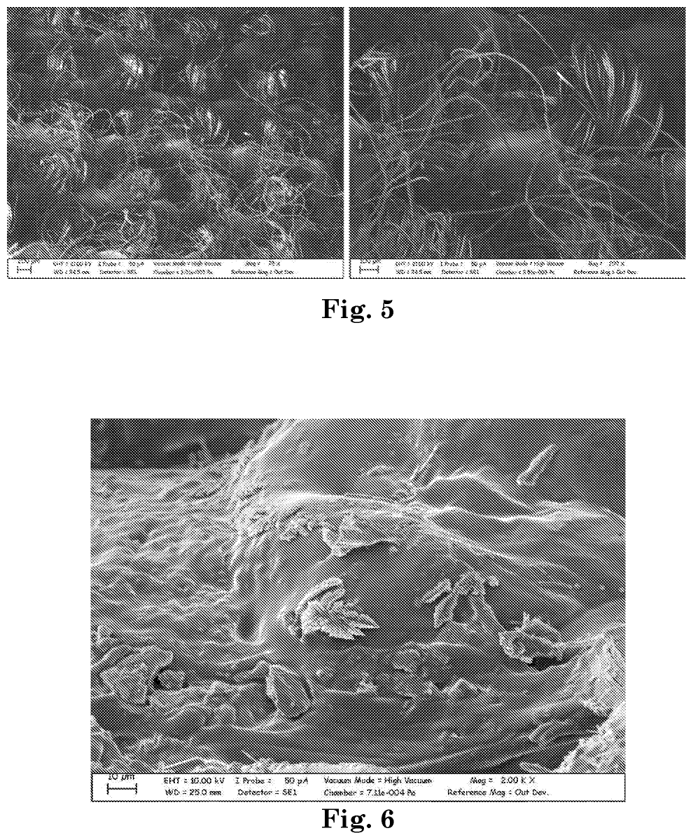

FIG. 5: shows SEM images with different magnification (75× and 200×) of the burnt area of an untreated fabric, following a flame-resistance test based on the Standard BS 5852 (part 1, MATCH TEST);

FIG. 6: shows a SEM image (2000×) of the burnt area of a fabric treated according to Example 4, following a flame-resistance test based on the Standard BS 5852 (part 1, MATCH TEST);

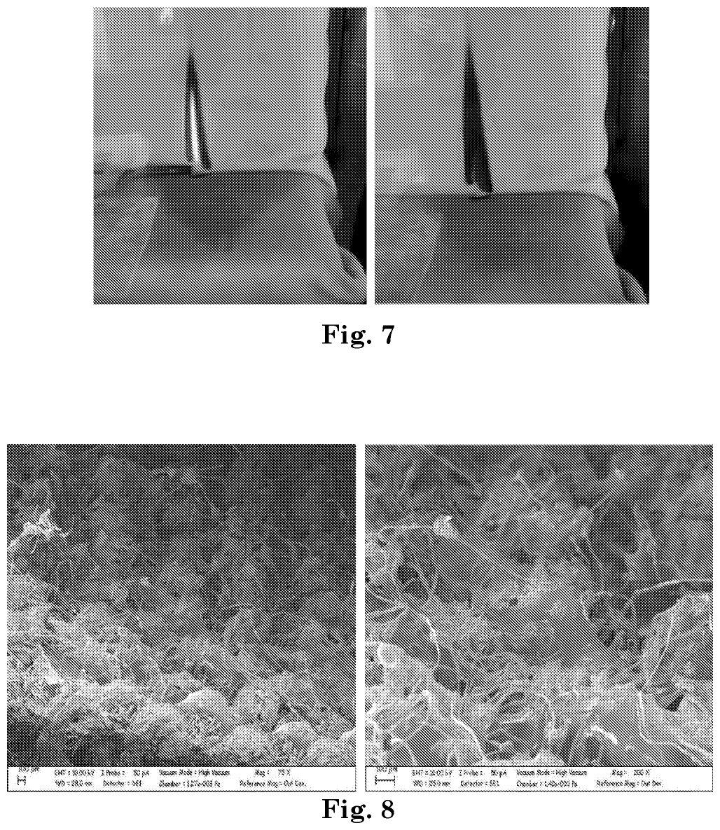

FIG. 7: shows a view of a seat lined with fabric which has been treated with a fire-retarding mixture according to Example 5 following a flame-resistance test based on the Standard BS 5852 (part 1, MATCH TEST);

FIG. 6: shows SEM images with different magnification (75× and 200×) of the burnt area of the fabric treated according to Example 5, following a flame-resistance test based on the Standard BS 5852 (part 1, MATCH TEST);

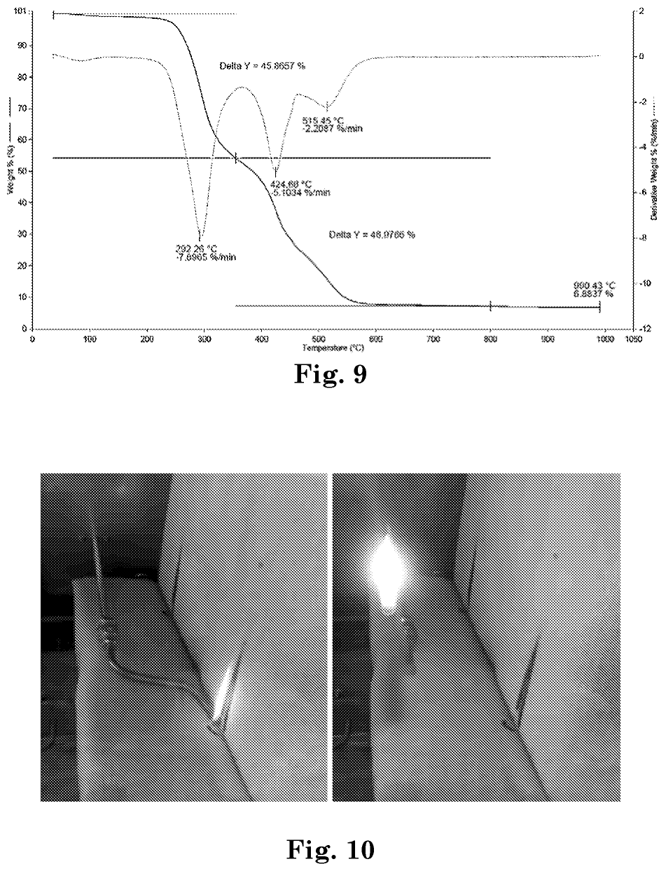

FIG. 9: shows a thermogravimetric analysis and a differential thermogravimetric curve for a fabric sample treated according to Example 5;

FIG. 10: shows a view of a seat lined with fabric which has been treated with a fire-retarding mixture according to Example 6 following a flame-resistance test based on the Standard BS 5852 (part 1, MATCH TEST);

According to the invention, a fire-retarding mixture is provided, said mixture comprising:
an aqueous solution of a base reagent consisting of an ammonium phosphate compound;
a carbonaceous component dispersed in the aqueous solution of the base reagent.

Preferably, the ammonium phosphate compound present in the aqueous solution is an ammonium acid salt, namely an ammonium salt of phosphoric acid, preferably chosen from ammonium phosphate monobasic NH₄H₂PO₄ and ammonium hydrogen phosphate (NH₄)₂HPO₄.

The quantity of the ammonium phosphate compound, for example of the ammonium acid salt, in the aqueous solution is preferably less than or equal to 600 g per litre of solution and preferably comprised between 25 and 400 grammes per litre of aqueous solution.

NH₄H₂PO₄ or (NH₄)₂HPO₄, as solutes of the solution, were chosen because of the flame-retarding characteristics of both the phosphorus and the nitrogen.

Using (NH₄)₂HPO₄, as solute results, in a solution with higher pH, neutral or slightly alkaline, which may be preferred for a safer industrial process.

The phosphorus compounds act both in the condensed phase and in the vapour phase when used as flame-retarding additives, for example dispersed in aqueous or polymer solutions.

The presence of nitrogen in NH₄ increases the fire-retarding characteristics of the phosphorus compounds and allows the release of gaseous nitrogen which dilutes the inflammable gases with a consequent reduction in the size of the flame.

Preferably, the carbonaceous component which is dispersed has a particle size of between 10 nm and 1000 nm, and more preferably between 10 nm and 600 nm.

Such a nanometric particle size is preferred since it allows a greater specific area and a better dispersion and coverage of the treated area to be obtained.

The carbonaceous component may be chosen from one of the following carbon fillers: carbon nanotubes and graphene oxide.

According to a preferred embodiment, the mixture comprises carbon nanotubes, preferably in a quantity equal to at least 0.01% by weight of the final mixture.

According to a further preferred embodiment of the mixture, the same comprises carbon nanotubes in a quantity comprised between 0.5% and 3% of mixture according to the invention, preferably between 1% and 2.5% or between 1.4% and 3% relative to the quantity of ammonium phosphate compound present in the mixture and the material to be treated.

According to a preferred embodiment, the mixture comprises graphene oxide in a quantity at least equal to 0.01% by weight of the mixture, preferably comprised between 0.1% and 2.5% of mixture according to the invention; preferably between 0.14% and 1% or between 0.2% and 1.45% relative to the quantity of ammonium phosphate compound present in the mixture and the material to be treated.

The mixture according to the invention may be obtained by means of dispersion of the carbonaceous component in the aqueous solution of the ammonium phosphate compound—preferably chosen from ammonium phosphate monobasic and ammonium hydrogen phosphate.

Preferably the mixture according to the invention is in the form of a colloidal dispersion of the carbonaceous component in the aqueous solution of ammonium phosphate compound.

The preferred minimum and maximum values of the different carbon fillers mentioned above define ranges within which a final mixture with optimum industrial applicability is obtained since it may be sprayed or applied by means of soaking and has a high fire-retarding efficiency.

The mixture according to the invention has a fire-retarding capacity already for relatively low concentrations of the carbonaceous component, for example greater than or equal to 0.01% by weight of the mixture; it is considered that this is due to the synergic interaction between the ammonium phosphate compound and the graphene oxide and/or carbon nanotubes.

Above the preferred maximum values indicated there is no percentage increase in the fire-retarding properties such as to justify the greater cost of the mixture. The quantity of reagents may be chosen in the composition ranges indicated depending on the desired effect and the fabric to be treated; for example, the preferred ranges with a greater quantity of dispersed carbonaceous component are particularly recommended for the treatment of synthetic fabrics, which are more inflammable.

The quantity of carbon fillers, in particular graphene oxide and/or carbon nanotubes, present in the solution according to the invention are able to optimize the capacity of these components to graphitize and form a “vitreous” layer or “char” layer during combustion; said layer is extremely compact, forming an optimum physical barrier against propagation of the heat and transportation of the material towards the combustion zone, limiting in fact propagation and further flame development.

In addition, graphene oxide offers two main advantages: the carboxyl, hydroxyl and epoxy groups present make the graphene relatively dispersible in water, preventing therefore the use of organic solvents, which are generally inflammable, and, moreover, since they are reactive chemical groups, they enable the functionalization of graphene with other chemical species such as phosphate and silane groups, which are particularly useful in flame-retarding applications.

In addition, the percentages by weight of carbon nanotubes listed above allow a suitable dispersion and therefore a compact char layer to be obtained during combustion.

Experimental tests have shown that, for the same concentration, the mixture according to the invention, comprising a carbonaceous component, has flame-retarding properties which are significantly better compared to those of a simple ammonium phosphate solution.

According to preferred embodiments, the mixture according to the invention may further comprise one or more additional carbonaceous components chosen from carbon black and expandable graphite which help formation of the char layer preventing expansion of the flame.

Carbon black consists generally of elementary carbon in the form of spherical particles with colloidal dimensions often subject to coalescence which causes the formation of particle agglomerates and aggregates. Preferably the carbon black is present in an amount greater than 0.05% and is preferably comprised between 0.3% and 4%, more preferably between 0.5% and 2.5%, by weight of the mixture. The expandable graphite is preferably present in an amount equal to at least 0.1% by weight of the mixture and preferably comprised between 0.05% and 3% by weight of the mixture. Preferably, in the various embodiments of the mixture of the invention, the interplanar distance of the crystalline graphite is 0.335 nm, while the interatomic distance between atoms of the same plane is 0.142 nm.

The different mixtures comprising one or more carbonaceous components dispersed in solution, for example ammonium phosphate monobasic or ammonium hydrogen phosphate also have different physical characteristics depending on the different chemical nature of the carbonaceous nanofiller.

By way of example, Table 1 below shows how, depending on the carbonaceous component introduced into an ammonium phosphate solution, the spraying efficiency of the solution may vary, said efficiency being of importance for industrial applications and in particular for application of the fire-retarding mixture of the invention to fabrics.

TABLE 1

| Solution | Dispersability | Sprayability |
|---|---|---|
| GO-FA | Excellent | |
| CNT-FA | Poor | |
| GO/CNT-FA | Average | |
| GO/CB-FA | Average | |
| GO/GE-FA | Excellent | |
| CNT/CB-FA | Poor | |
| CNT/CE-FA | Average | |

wherein:
GO-FA = NH₄H₂PO₄/(NH₄)₂HPO₄ + graphene oxide
CNT-FA = NH₄H₂PO₄/(NH₄)₂HPO₄ + carbon nanotubes
GO/CNT-FA = NH₄H₂PO₄/(NH₄)₂HPO₄ + graphene oxide + carbon nanotubes
GO/CB-FA = NH₄H₂PO₄/(NH₄)₂HPO₄ + graphene oxide + carbon-black
GO/GE-FA = NH₄H₂PO₄/(NH₄)₂HPO₄ + graphene oxide + expandable graphite
CNT/CB-FA = NH₄H₂PO₄/(NH₄)₂HPO₄ + carbon nanotubes + carbon-black
CNT/GE-FA = NH₄H₂PO₄/(NH₄)₂HPO₄ + carbon nanotubes + expandable graphite

The different degree of dispersion of the carbonaceous component in the aqueous solution depends on the presence or not of polar groups, namely carbonyl (carboxyl, epoxy, etc.) groups on the surface of the carbon fillers; it emerges in fact that the reduced forms of carbon, such as CNT, GE and CB, have a low content of these groups and a low degree of dispersion in solution.

On the other hand, oxidised structures such as GO ensure a good dispersion.

In order to ensure the spreadability of one of the aqueous mixtures of the invention described hitherto, for example in order to obtain a viscosity greater than 2500 cPa, preferably comprised between 4000 and 5000 cPa, the mixture may be mixed with a water-based polymeric emulsion, namely an emulsion comprising a polymer dispersed in an aqueous medium, for example polyurethane, polyacrylic, EVA, polystyrene or a latex, such as a butadiene latex, for example a styrene-butadiene copolymer latex, and/or with a wetting agent and/or a thickener. The polymeric emulsion should be at least equal to 0.5% by weight of the final mixture and preferably comprised between 5% and 25% by weight of the final mixture. Generally the solid polymer part may be for example comprised between 40% and 60% by weight of the polymeric emulsion.

In a further preferred variation of embodiment, it is envisaged that a mixture according to the invention, in particular for application to fabrics by means of spreading, comprises:
an aqueous solution of an ammonium phosphate compound; preferably an ammonium acid salt chosen from ammonium phosphate monobasic NH₄H₂PO₄ and ammonium hydrogen phosphate (NH₄)₂HPO₄;
a carbonaceous component dispersed in the aqueous solution of the base reagent, chosen from among graphene oxide, carbon nanotubes, expandable graphite, carbon black or combinations thereof.
   for example in the quantities indicated for any preferred embodiment described hitherto, and
a additive polymeric dispersion comprising
a polymeric binder consisting of a water-based polymeric emulsion, for example polyurethane, polyacrylic, EVA, polystyrene or a latex such as a styrene-butadiene latex or, more generally, a butadiene based latex.
titanium dioxide (TiO₂) in dispersed phase;
lignin in dispersed phase;
   the additive polymeric dispersion being preferably present in a quantity at least equal to 0.5% by weight of the final mixture and preferably comprised between 5% and 25% by weight of the final mixture.

According to these preferred embodiments, a fire-retarding mixture according to one of the embodiments described above, or in which the carbonaceous component consists of carbon black and/or expandable graphite, is therefore mixed with (incorporated in) an emulsion or water-based additive polymeric dispersion in order to obtain a product particularly suitable for being spread over a surface to be treated. The preferred minimum values and the preferred ranges of carbonaceous component mentioned above must in this case be calculated based on the weight of the final mixture (mixed with the additive polymeric dispersion or the polymeric emulsion). The use of expandable graphite, preferably obtained from crystalline graphite formed by planes of sp2 hybridized carbon atoms arranged, usually, in the form of a regular hexagonal lattice, improves considerably the fire-resistance characteristics of the polymer matrix or dispersion in which it is dispersed in the mixture according to the invention. This improvement is due to a particular property of expandable graphite, namely the possibility of expanding up to one hundred times its initial thickness, when exposed to sufficiently high temperatures.

The presence of carbon black allows thermal stabilization of the polymer in the polymer matrix or dispersion which it is dispersed in the mixture according to the invention. It is considered, without being limited to any one theory, that the effect may be induced by trapping of the free radicals produced by the decomposition of the polymer matrix by the carbon black particles which form a compact graphitized structure inside the polymer. The effect is improved when carbon black is present in an amount greater than 0.05% and preferably comprised between 0.3% and 4%, more preferably between 0.5% and 2.5%, by weight of the final mixture.

Preferably, the amount of additive polymeric dispersion does not exceed 25% by weight of the final mixture.

It comes within the competence of a person skilled in the art to select the ammonium phosphate compound depending on the pH of the polymeric binder in order to avoid crosslinking of the polymer induced by the pH. For example, the ammonium phosphate compound may be hydrogen phosphate for alkaline pH values of the polymeric binder or dihydrogen phosphate for medium acid pH values. Likewise it is within the competence of the person skilled in the art to choose alkaline or sulfonated lignin depending on the pH of the polymeric binder.

Preferably it is also envisaged:
that the binder is a butadiene-based resin (aqueous polymer dispersion), preferably a styrene-butadiene (SB) latex, which also has non-fraying properties; in this case the lignin will consist of alkaline lignin.

According to preferred embodiments, it is also envisaged that the additive polymeric dispersion comprises:
at least 50% and preferably less than 92% by weight (of the additive polymeric dispersion) of polymeric binder; and/or
at least 4% and preferably between 4% and 15%, even more preferably between 4% and 10%, by weight (of the additive polymeric dispersion) of titanium dioxide TiO₂; and/or
at least 4% and preferably between 4% and 15%, even more preferably between 4% and 10%, by weight (of the additive polymeric dispersion) of lignin.

Preferably the titanium dioxide TiO₂ is in the form of nanoparticles of TiO₂ with a size greater than or equal to 10 nm and less than or equal to 100 nm, preferably comprised between 20 nm and 50 nm.

According to the invention, a process for the production of a fire-retarding mixture according to the invention is envisaged, said process comprising the following steps:
preparing water, a base reagent consisting of an ammonium phosphate compound and a carbonaceous component;
solubilization of the ammonium phosphate compound in water;
dispersion of the carbonaceous component in the aqueous solution;
stirring the mixture until the carbonaceous component is uniformly dispersed.

The dispersion thus obtained is subjected to heat treatment at a temperature greater than or equal to 65°, for a period preferably of between 1 hour and 48 hours, preferably between 12 hours and 24 hours.

The carbonaceous component may be equally well dispersed before or after the addition of the ammonium phosphate compound in water.

According to the invention it is envisaged preferably that:
the ammonium phosphate compound is an ammonium acid salt, namely an ammonium salt of phosphoric acid, preferably chosen from ammonium phosphate monobasic NH₄H₂PO₄ and ammonium hydrogen phosphate (NH₄)₂HPO₄;
the ammonium phosphate compound is added in an amount such that the concentration of ammonium phosphate compound is comprised between 25 and 600 grammes, preferably less than or equal to 400 grammes, per litre of aqueous solution.
the carbonaceous component is chosen from:
   carbon nanotubes in an amount equal to at least 0.01% by weight, preferably comprised between 0.5% and 4% of mixture according to the invention; preferably between 1% and 2.5% or between 1.4% and 3.4% relative to the quantity of ammonium phosphate compound present in the mixture.

Graphene oxide in an amount equal to at least 0.01% by weight, preferably comprised between 0.1% and 2.5% of mixture according to the invention; preferably between 0.14% and 1% or between 0.2% and 1.45% relative to the quantity of ammonium phosphate compound present in the mixture.

The step of dispersion of a carbonaceous component may also preferably comprise the dispersion of an additional carbonaceous component consisting of carbon black and/or expandable graphite; the carbon black may be dispersed in an amount greater than 0.05% and preferably comprises between 0.3% and 4%, more preferably between 0.5% and 2.5% by weight of the mixture.

The expandable graphite may be dispersed in an amount equal to 0.1% by weight of the mixture and preferably comprised between 0.05% and 3% by weight of the mixture.

An example of embodiment of a method for the production of a mixture according to the invention, in the form of an aqueous fire-retarding dispersion, may comprise the following steps:
pouring a quantity of demineralized water inside a suitable container, such as a beaker;
stirring the demineralized water, for example using a heater stirrer,
adding the carbonaceous component (graphene oxide and/or carbon nanotubes) and optionally the additional carbonaceous component, mixing for a suitable time period, generally 30 minutes or more;
adding the ammonium phosphate compound, e.g. an ammonium salt of phosphoric acid, while keeping the mixture constantly stirred;
continuing stirring until the ammonium phosphate compound is completely dissolved and the carbonaceous component is uniformly dispersed in the aqueous solution.

At the end of this step the aqueous dispersion containing the carbonaceous material is heated to a temperature higher than 65°, preferably about 70° C., kept at this temperature for a period of between 1 hour and 48 hours, preferably between 12 hours and 24 hours, while continuing to stir and keeping the volume constant, for example by means of a reflux condenser.

According to a further embodiment of the process it is envisaged that the solution is mixed with a water-based polymeric emulsion or a additive polymeric dispersion, added in an amount at least equal to 0.5% by weight of the final mixture and preferably comprised between 5% and 25% by weight of the final mixture.

The water-based polymeric emulsion is preferably chosen from among polyurethane, polyacrylic, polystyrene, EVA or a latex, such as a styrene-butadiene latex or, more generally, a butadiene-based latex.

The additive polymeric dispersion comprises:
a polymeric binder consisting of a water-based polymeric emulsion, for example polyurethane, polyacrylic, polystyrene, EVA or a latex such as a styrene-butadiene latex or, more generally, a butadiene based latex.
titanium dioxide (TiO₂),
lignin.

In this latter case, the carbonaceous component may alternatively consist of carbon black and/or expandable graphite, for example in the preferred amounts previously indicated in connection with the additional carbonaceous component.

Preferably it is envisaged that the binder is a styrene-butadiene (SB) resin (a latex) known for its non-fraying properties.

The final mixture, which is generally in the form of a colloidal dispersion, may also be foamed for application to the fabric.

The present invention relates furthermore to a fire-retarding fabric comprising a fabric base layer to which a mixture according to any one of the embodiments as described above is applied.

In a variation of embodiment in which the fabric is treated with a mixture according to the invention comprising a additive polymeric dispersion, for example comprising a resin (i.e. a latex) of styrene-butadiene (SB), titanium dioxide (TiO₂) and alkaline lignin, the mixture will comprise a quantity by weight of SB latex which may be chosen depending on the characteristics of the fabric to which the mixture is applied; by way of example, mixtures comprising per 100 g of additive polymeric dispersion:

83 g of SB latex+8.5 g of TiO₂+8.5 g of alkaline lignin

were tested.

The mixture according to the invention may be applied to a fabric by means of direct spraying onto the back thereof, or by means of application by soaking or, if mixed with a polymeric emulsion or a additive polymeric dispersion, by means of spreading.

Preferably, the mixture applied to the fabric is foamed beforehand.

The process of foaming the mixture according to the invention envisages stirring the mixture inside a storage tank and supplying at room temperature to a foaming machine where the density values (g/I) and dispensing rate (preferably an average value of about 55 I/h) for the final product have been preset.

The mixture subjected to foaming may be easily applied to the fabric, in particular by means of conventional back-coating processes.

The fire-retarding mixture comprising an emulsion or a additive polymeric dispersion may be applied, preferably sprayed or spread, on the back of a fabric, for example by means of a film spreader blade. Preferably, the layer of applied mixture has a thickness of at least 0.1 mm, preferably comprised between 1 and 4 mm, more preferably between about 1.5 and 2.5 mm. Preferably, the fabric is kept tensioned during application of the mixture, so as to obtain a uniform coating.

At the end of the application process, the treated fabric is subjected to a heat treatment at a temperature of between 100° C. and 180° C., preferably between 120° C. and 160° C. for a period of between 1 and 20 minutes, preferably between 2 and 10 minutes. The heat treatment causes crosslinking of the polymer phase of the mixture, with formation of a layer of film comprising a polymer matrix with a carbonaceous component in the dispersed phase inside it. During this phase the thickness of the mixture layer applied may be reduced.

In the case of an aqueous mixture according to the invention, without a polymer phase, the heat treatment is not necessary, but may be preferable in order to accelerate evaporation of the water until complete drying of the treated fabric occurs. Preferably, in this case, the heat treatment is performed at a temperature not greater than 120° C.

Following application and any heat treatment, the resultant fabric will have a thin fire-retarding layer obtained from the mixture applied, with a thickness of at least 0.05 mm, preferably comprised between 0.1 mm and 3 mm, preferably between 0.1 and 2.5 mm.

The weight of the fire-retarding layer obtained is preferably less than 70% of the weight of the fabric per square metre, generally between 10 and 70%, more preferably between 20% and 40%, of the weight of the fabric per square metre.

### EXAMPLES AND TEST DATA

The tests shown in FIGS. 1-3 and described below were carried out on a sample of a portion of 1 square metre of fabric VV SENIB (composition: viscose 81%; cotton 16%; polyester 3%) with which a seat was lined.

The fabric was exposed for a period of 21 s to a flame fuelled with Butane 1950 (2.8 kPa output pressure and approx. 45 ml/min flowrate), similar to the flame produced by a match. The burner pipe had dimensions of about 200 mm length, 6.5 mm internal diameter and 8 mm external diameter.

The height of the flame applied was about 35 mm. The blowtorch was arranged parallel to the point of intersection between backrest and seat.

### Example 1—Prior Art

The fabric sample was not treated with fire-retarding compounds.

As shown in FIG. 1a, the exposure to the flame of the blowtorch for 21 s at several points produced combustion and the fabric caught fire; once the blowtorch was removed it was necessary for the operator to intervene in order to extinguish the flame which, after about 120 s, was still alight.

Once the flame was extinguished, a burnt area of about 120 cm² was left at the end of each burning test (black areas in FIG. 1b).

### Example 2

A similar fabric sample was treated applying by means of spraying a volume equal to about 500 ml of mixture according to the invention comprising:
25 grammes of ammonium phosphate monobasic NH₄H₂PO₄ per litre of aqueous solution;
0.3% by weight of the final mixture of graphene oxide.

Exposure of different areas of the fabric to the flame of the blowtorch for 21 s produced combustion and the fabric caught fire; once the blowtorch was removed, the flame self-extinguished in about 6 to 12 s.

Once extinguished, a burnt area of about 27 cm² was left at the end of each burning test, as shown in FIG. 2.

### Example 3

A similar fabric sample was treated applying by means of spraying a volume of 500 ml of mixture according to the invention comprising ammonium phosphate monobasic NH₄H₂PO₄, carbon nanotubes and a fire-retarding additive polymeric dispersion based on a styrene-butadiene (SB) copolymer latex, TiO₂, and alkaline lignin. The composition per 100 g of additive polymeric dispersion was as follows:

83 g of SB latex+8.5 g of TiO₂+8.5 g of alkaline lignin

Exposure of different areas of the fabric to the flame of the blowtorch for 21 s produced combustion and the fabric caught fire; once the blowtorch was removed, the flame self-extinguished in less than 12 s.

Once extinguished, a burnt area of about 12 cm² was left at the end of each burning test (black areas numbered in FIG. 3).

### Example 3b

A similar fabric sample was treated applying by means of spraying a volume of 500 ml of mixture according to the invention (with base reagent consisting of ammonium hydrogen phosphate and carbonaceous component consisting of 0.3% by weight of graphene oxide) to which a fire-retarding mixture additive based on SB latex, TiO₂, and alkaline lignin was added. The composition per 100 g of additive polymeric dispersion was as follows: 83 g of SB latex+8.5 g of TiO₂+8.5 g of alkaline lignin.

Exposure of different areas of the fabric to the flame of the blowtorch for 21 s produced combustion and the fabric caught fire; once the blowtorch was removed, the flame self-extinguished in less than 7 s.

### Example 4

The amounts and composition percentages shown in Table 2 relate to the preparation of 1 kg of mixture in the form of a fire-retarding aqueous dispersion for the respective components used.

TABLE 2
Composition percentages and weight of the materials
for the preparation of 1 kg of final product.

| Component | Quantity [g] | Composition percentage (%) |
|---|---|---|
| Demineralized water | 763.4 | 76.34 |
| Ammonium phosphate | 229 | 22.9 |
| monobasic | | |
| Graphene oxide | 7.6 | 0.76 |

An example of a fire-retarding aqueous dispersion according to the invention was prepared as follows: 763.4 g of demineralized water were poured into a beaker and stirred at 250 rpm using an AREX 630W VELP SCIENTIFICA heater stirrer. 7.6 g of graphene oxide were added to this volume of water with mixing for 30 minutes, at the end of which 229 g of ammonium phosphate monobasic were added while stirring constantly. Stirring was continued until the salt was completely dissolved. At the end of this step the aqueous dispersion containing the carbonaceous material was heated to 70°, kept at this temperature for a period of between 12 hours and 24 hours, while continuing to stir and keeping the volume constant by means of a reflux condenser.

In the case of this example, 0.050 l of dispersion thus prepared were sprayed onto the back of a fabric with an area of 1 m² and composition VI 59%, CO 24% and PL 17%. At the end of the spraying process, the treated fabric was subjected to a heat treatment at a temperature of between 100° C. and 120° C. for a period of between 10 and 20 minutes. At the end of the procedure, the fabric thus treated was left at room temperature for 24 hours and tested for its flame resistance.

The fabric was exposed to a flame fuelled with Butane 1950 (2.8 kPa output pressure and approx. 45 ml/min flowrate), similar to the flame produced by a match. The burner pipe had dimensions of about 200 mm length, 6.5 mm internal diameter and 8 mm external diameter. The height of the flame applied was about 35 mm. The blowtorch was arranged parallel to the point of intersection between backrest and seat of a prototype suitably lined with the treated fabric and the flame remained in contact with the fabric for about 21 s. At the end of the test the self-extinguishing time and the area of burnt fabric were assessed.

### Test Data

Flame Resistance Test

The flame test procedure is identical for all the examples. The results obtained using the fabric treated according to Example 4 are shown in FIG. 4.

Upon removal of the blowtorch, no free flame was present on the contact surface and the burnt area at the end of the flame test was equal to about 12.5 cm².

FIG. 4 shows the result of the flame resistance test, with positive outcome. Upon removal of the blowtorch, no free flame was present on the contact surface and the burnt area at the end of the flame test was equal to about 12.5 cm².

Scanning Electron Microscopy (SEM)

FIG. 6 shows an SEM image of the fabric treated according to Example 4 and analyzed after the flame resistance test in accordance with the standard BS 5852.

If compared with the SEM image of the burnt area of the same fabric without treatment (FIG. 5) it can be seen how, following contact with the flame, the fabric treatment according to Example 4 resulted in the formation of an extremely compact char layer able to protect the fabric from flame propagation.

### Example 5

The quantities and composition percentages shown in Table 3 relate to the preparation of 1 kg of fire-retarding aqueous dispersion for the respective components used.

TABLE 3
Composition percentages and weight of the materials
for the preparation of 1 kg of final product.

| Component | Quantity [g] | Composition percentage (%) |
|---|---|---|
| Demineralized water | 709.20 | 70.92 |
| Ammonium hydrogen | 283.70 | 28.37 |
| phosphate | | |
| Graphene oxide | 7.10 | 0.71 |

For the preparation of the fire-retarding aqueous dispersion of this example 709.20 g of demineralized water were poured into a beaker and stirred at 250 rpm using an AREX 630W VELP SCIENTIFICA heater stirrer. 7.10 g of graphene oxide were added to this volume of water with mixing for 30 minutes, at the end of which 283.70 g of ammonium hydrogen phosphate were added while stirring constantly until the salt was completely dissolved. At the end of this step the aqueous dispersion containing the carbonaceous material was heated to 70°, kept at this temperature for a period of between 1 hours and 48 hours, preferably between 12 and 24 hours, while continuing to stir and keeping the volume constant by means of a reflux condenser.

In the case of this Example 5, 0.045 l of dispersion thus prepared were sprayed onto the back of a fabric with an area of 1 m² and composition: VI 59%, CO: 24% and PL: 17%. At the end of the spraying process, the treated fabric was subjected to a heat treatment at a temperature of between 80° C. and 120° C. for a period of between 10 and 20 minutes.

At the end of the procedure, the fabric thus treated was left at room temperature for 24 hours and tested for its flame resistance.

### Test Data

Flame Resistance Test

The flame test procedure is identical to that carried out for the preceding examples. The results obtained using the treated fabric according to Example 2 are shown in FIG. 7, where a burnt area of about 13 cm² can be seen at the end of the flame test.

Thermogravimetric Analysis:

The fabric treated by means of spraying was characterized by means of a thermogravimetric analysis (TGA) where the variation in mass of the sample over time as a result of the rising temperature (bold curve) was monitored. In this particular case the temperature range analyzed ranges from 30° C. to 1000° C. in air, with a temperature ramp of 10° C./min, without pre-treatment, so as to approximate in best possible manner the real conditions.

In FIG. 9 it is possible to see the percentage mass loss of the treated fabric as a function of the temperature. The same graph also shows the differential thermogravimetric curve (DTG, faint line) representing the speed of mass loss of the sample analyzed as a function of the temperature. In order to simulate the real burning test, the test was carried out in air.

From FIG. 9 it can be seen how the residual percentage mass of the treated fabric at 1000° C. is equal to 6.8837%, while in the case of the non-treated fabric the residual mass at 1000° C. is equal to 0.

Scanning Electron Microscopy (SEM)

Comparing FIGS. 5 and 8 it is possible to note the effects of the fire-retarding treatment described in Example 5 and applied by means of spraying on the fabric: in the case of non-treated fabric (FIG. 5), the fibres of the fabric, when exposed to the flame, are unable to form a compact char layer and are subject to gradual breakage, with consequent continuous ignition of the said fabric.

In the case of the treated fabric (FIG. 8) it is possible to note how the interaction of the fabric with the flame caused the formation of a continuous and compact char layer, providing an effective barrier against flame propagation.

### Example 6

The quantities and composition percentages shown in Table 4 relate to the preparation of 1 kg of fire-retarding aqueous dispersion for the respective components used.

TABLE 4
Composition percentages and weight of the materials
for the preparation of 1 kg of final product.

| Component | Quantity [g] | Composition percentage (%) |
|---|---|---|
| Demineralized water | 793.6 | 79.36 |
| Ammonium phosphate | 198.4 | 19.84 |
| monobasic | | |
| Graphene oxide | 0.8 | 0.08 |
| Expandable graphite | 7.2 | 0.72 |

For the preparation of the fire-retarding aqueous dispersion of this example 793.6 g of demineralized water were poured into a beaker and stirred at 250 rpm using an AREX 630W VELP SCIENTIFICA heater stirrer. 0.8 g of graphene oxide and 7.2 g of expandable graphite were added to this volume of water with mixing for 30 minutes, at the end of which 198.40 g of ammonium phosphate monobasic were added while stirring constantly. Stirring was continued until the salt was completely dissolved. At the end of this step the aqueous dispersion containing the carbonaceous material was heated to about 70°, kept at this temperature for a period of 10 hours, while continuing to stir and keeping the volume constant by means of a reflux condenser.

At the end of the procedure, the fire-retarding aqueous dispersion was applied onto a fabric. 0.035 L of dispersion thus prepared were sprayed onto the back of a fabric with an area of 1 m² and composition: VI 30%, CO 70%. At the end of the spraying process, the treated fabric was subjected to heat treatment at a temperature of between 80° C. and 120° C. for a period of at least 15 minutes.

At the end of the procedure, the fabric thus treated was left at room temperature for 24 hours and tested for its flame resistance.

### Test Data

Flame Resistance Test

The flame test procedure is identical for all the examples already described. The results obtained using the fabric treated according to Example 6 are shown in FIG. 10. Upon removal of the blowtorch, no free flame was present on the contact surface and the burnt area at the end of the flame test was about 11 cm².

Substantially similar results were obtained with the same combination of carbonaceous materials dispersed in an aqueous solution containing ammonium hydrogen phosphate in the quantities shown in Table 5.

TABLE 5
Composition percentages and weight of the materials
for the preparation of 1 kg of final product

| Component | Quantity [g] | Composition percentage (%) |
|---|---|---|
| Demineralized water | 708.7 | 70.87 |
| Ammonium hydrogen | 283.5 | 28.35 |
| phosphate | | |
| Graphene oxide | 1.4 | 0.14 |
| Expandable graphite | 6.4 | 0.64 |

### Example 7

In the example, a styrene-butadiene copolymer latex (SB latex) was used as polymeric emulsion: for 0.9 kg of SB latex 0.05 kg of nanoparticles of TiO₂ of 10-100 nm size were added a little at a time while keeping the aqueous dispersion stirred at a speed of between 20 and 100 rpm.

A same quantity of alkaline lignin was added in the same manner, so as to obtain a additive polymeric dispersion consisting of 90% by weight of SB latex and 5% by weight of nanoparticles of TiO₂ and alkaline lignin in each case. The additive polymeric dispersion thus obtained is called “composite SB latex”.

The fire-retarding ammonium phosphate solution was instead prepared according to the procedure described in Example 5. Table 6 shows the composition values of the fire-retarding solution.

TABLE 6
Composition of the fire-retarding solution

| Material | Percentage (wt %) |
|---|---|
| Demineralized H2O | 65.7 |
| Ammonium phosphate dibasic | 33 |
| Graphene oxide | 1.3 |

A wetting agent (Kollasol HV produced by CHT) was added to the fire-retarding solution in an amount equal to 5 g per kg of solution, and the solution mixed mechanically at room temperature for 30 mins at 300 rpm. The solution was finally added to the composite SB latex a little at a time, while keeping the latex stirred at 20-50 rpm, in an amount equal to three times the weight of the composite SB latex.

For this example, 3 kg of fire-retarding solution with wetting agent were added for every 1 kg of composite SB latex. In order to adjust the polymer dispersion thus obtained to an optimum viscosity for the spreading process, a polymer thickener (TUBICOAT VERDICKER LP produced by CHT) was added in amounts of between 15 and 40 g per kg, preferably between 20 and 30 g/kg; in the example about 25 g per kg of final mixture were used.

The polymer dispersion was continuously mixed at 100 rpm for at least 60 mins until a fluid polymer dispersion with a viscosity of between 4000 and 5000 cPa was obtained, the composition thereof being summarised in Table 6a.

TABLE 6a
Composition of the fire-retarding mixture with additive
polymeric dispersion according to Example 7

| Material | Quantity [g] | Percentage (%) |
|---|---|---|
| Demineralized H2O | 1971 | 47.8 |
| Ammonium phosphate | 990 | 24 |
| dibasic | | |
| Graphene oxide | 39 | 0.94 |
| Kollasol HV | 20 | 0.48 |
| SB Latex | 900 | 21.8 |
| TiO₂ | 50 | 1.28 |
| Alkaline lignin | 50 | 1.28 |
| Verdicker LP | 100 | 2.42 |

The final mixture thus obtained was applied onto the back of the fabric by means of a blade coating process, using a blade of adjustable height. In particular the mixture was applied in thicknesses of 100 to 400 μm onto fabrics of varying composition. The fabric was then treated thermally at 160° C. for 5 minutes so as to favour the crosslinking of the polymer phase and evaporation of the solvent. The treated fabrics were then tested by means of the Limiting Oxygen Index (LOI) test based on the standard DIN 4586, part 2. The LOI values of the untreated fabric, of the fabric on the untreated surface (front) and of the fabric on the treated surface (rear) are shown in Table 7. The effectiveness of the fire-retarding mixture and the treatment is shown by the considerable increase in the LOI values both on the front and on the rear of the fabric. In particular, for the fabric with composition CO 60 PES 40 an excellent fire-retarding effect is obtained at thicknesses of 300 and 400 μm, with values greater than 32, indicating that the material does not catch fire despite direct and prolonged contact over time with a flame.

TABLE 7
LOI values for fabrics with different composition and
different thicknesses of the polymer film applied

| Fabric | Thickness | LOI | LOI | LOI |
|---|---|---|---|---|
| composition | (μm) | (untreated) | front | rear |
| PES 80 WO 20 | 100 | 21.3 | 30.8 | — |
| | 200 | | 31.4 | — |
| | 300 | | 31.7 | — |
| | 400 | | 32.4 | — |
| CO 60 PES 40 | 100 | 18.3 | 29.8 | 34.6 |
| | 200 | | 30.5 | 35.6 |
| | 300 | | 33.2 | 35.8 |
| | 400 | | 33.3 | 35.6 |
| PAC 100 | 100 | 18.7 | 25.7 | 26.5 |
| | 200 | | 25.9 | 28.3 |
| | 300 | | 26.9 | 30.3 |
| | 400 | | 27.2 | 30.2 |

Further examples of mixtures according to the invention and methods for production of a mixture according to the invention are shown below.

### Example 8

The quantities and composition percentages shown in Table 8 relate to the preparation of 1 kg of fire-retarding aqueous dispersion for the respective components used.

TABLE 8
Composition percentages and weight of the materials for the
preparation of 1 kg of the mixture according to the invention

| Component | Quantity [g] | Composition percentage (%) |
|---|---|---|
| Demineralized water | 790.5 | 79.05 |
| Ammonium phosphate | 197.6 | 19.76 |
| monobasic | | |
| Graphene oxide | 7.9 | 0.79 |
| Carbon black | 4 | 0.4 |

The preparation took place in a manner similar to that shown for Examples 1 to 3 The resultant fire-retarding aqueous dispersion may be applied by means of spraying onto the back of a fabric or by means of soaking of the fabric. The quantity of mixture to be applied depends on the type of fabric to be treated.

### Example 9

The quantities and composition percentages shown in Table 6 relate to the preparation of 1 kg of fire-retarding aqueous dispersion for the respective components used.

TABLE 10
Composition percentages and weight of the materials
for the preparation of 1 kg of final product.

| Component | Quantity [g] | Composition percentage (%) |
|---|---|---|
| Demineralized water | 727.3 | 72.73 |
| Ammonium polyphosphate | 254.5 | 25.45 |
| Carbon nanotubes | 18.2 | 1.82 |

For the preparation of this example of mixture according to the invention 727.3 g of demineralized water are poured into a beaker and stirred at 250 rpm using an AREX 630W VELP SCIENTIFICA heater stirrer. 18.2 g of carbon nanotubes are added to this volume of water with mixing for 30 minutes, at the end of which 254.50 g of ammonium polyphosphate are added while stirring constantly. Stirring is continued until the salt is completely dissolved. At the end of this step the aqueous dispersion containing the carbonaceous material is heated to about 70°, kept at this temperature for a period of 24 hours, while continuing to stir and keeping the volume constant by means of a reflux condenser.

At the end of the procedure, the fire-retarding aqueous dispersion may be applied onto the back of a fabric by means of spraying.

The fabric thus treated is left at room temperature for 24 hours.

### Example 10

The quantities and the percentage compositions of the mixture according to Example 10 are shown in Table 11 and relate to the preparation of 1 kg of mixture in the form of an aqueous dispersion.

TABLE 11
Composition percentages and weight of the materials
for the preparation of 1 kg of final product.

| Component | Quantity [g] | Composition percentage (%) |
|---|---|---|
| Demineralized water | 692.1 | 69.21 |
| Ammonium phosphate | 276.8 | 27.68 |
| monobasic | | |
| Carbon nanotubes | 20.7 | 2.07 |
| Carbon black | 10.4 | 1.04 |

For preparation, 692.1 g of demineralized water are poured into a beaker and stirred at 250 rpm on an AREX 630W VELP SCIENTIFICA heater stirrer. 20.7 g of carbon nanotubes and 10.4 g of carbon black are added to this volume of water with mixing for 30 minutes, at the end of which 276.8 g of ammonium phosphate monobasic are added while stirring constantly. Stirring of the aqueous dispersion thus obtained is continued until the salt is completely dissolved. At the end of this step the aqueous dispersion containing the carbonaceous material is heated to 70°, kept at this temperature for a period of about 24 hours, while continuing to stir and keeping the volume constant by means of a reflux condenser.

The fire-retarding aqueous dispersion produced is suitable for application to a surface, in particular to the back of a fabric by means of spraying or by means of soaking of the fabric.

It is therefore clear how the mixture according to the invention has an optimum fire-retarding efficiency, is ecological and easily applied on an industrial level.

Although described in connection with a number of embodiments and a number of preferred examples of embodiment of the invention, it is understood that the scope of protection of the present patent is determined solely by the claims below.

1-34. (canceled)

35. Fire-retarding mixture, comprising:
an aqueous solution of an ammonium phosphate compound;
a carbonaceous component dispersed in the aqueous solution;
wherein the carbonaceous component is chosen from: carbon nanotubes, graphene oxide or a combination thereof.

36. Fire-retarding mixture according to claim 35, characterized in that it comprises an additional carbonaceous component consisting of carbon black and/or expandable graphite.

37. Fire-retarding mixture according to claim 36, characterized in that it comprises carbon black in a quantity greater than or equal to 0.05% by weight, and preferably comprised between 0.3% and 4%, more preferably between 0.5% and 2.5% by weight of the mixture.

38. Fire-retarding mixture according to claim 36, characterized in that it comprises expandable graphite, the quantity of which is equal to at least 0.01% by weight of the mixture and preferably comprised between 0.05% and 3% by weight of the mixture.

39. Fire-retarding mixture according to claim 35, characterized in that it comprises carbon nanotubes, in a quantity equal to at least 0.01% by weight of the mixture and preferably comprised between 0.5% and 3% by weight of the mixture.

40. Fire-retarding mixture according to claim 35, characterized in that it comprises graphene oxide, in a quantity equal to at least 0.01% and preferably comprised between 0.1% and 2.5% by weight of the mixture.

41. Fire-retarding mixture according to claim 35, characterized in that it further comprises a water-based polymeric emulsion.

42. Fire-retarding mixture according to claim 35, characterized in that it comprises an additive polymeric dispersion comprising:
a binder consisting of a water-based polymeric emulsion;
titanium dioxide (TiO₂),
lignin.

43. Fire-retarding mixture, comprising:
an aqueous solution of an ammonium phosphate compound;
an additive polymeric dispersion comprising
a binder consisting of a water-based polymeric emulsion;
titanium dioxide (TiO₂),
lignin.
a dispersed carbonaceous component chosen from: carbon black, expandable graphite or a combination of these.

44. Mixture according to claim 41, characterized in that the polymeric emulsion or the additive polymeric dispersion is in a quantity greater than or equal to 0.5% by weight of the mixture, preferably less than 25%, more preferably comprised between 5% and 25% by weight of the mixture.

45. Mixture according to claim 42, characterized in that the additive polymeric dispersion comprises:
at least 50% by weight of a water-based polymeric emulsion;
between 4% and 15% by weight of titanium dioxide TiO₂;
between 4% and 15% by weight of lignin.

46. Mixture according to claim 43, comprising carbon black in a quantity greater than 0.05% and preferably comprised between 0.3% and 4%, more preferably between 0.5% and 2.5% by weight of the mixture.

47. Mixture according to claim 43, characterized in that it comprises expandable graphite, the quantity of which is equal to at least 0.01% by weight of the mixture and preferably comprised between 0.05% and 3% by weight of the mixture.

48. Mixture according to claim 35, characterized in that it is foamed.

49. Mixture according to claim 41, characterized in that the water-based polymeric emulsion is chosen from polyurethane, polyacrylic, polystyrene, ethylene vinyl acetate EVA or a butadiene based latex, preferably a styrene-butadiene latex.

50. Fire-retarding mixture according to claim 35, characterized in that the ammonium phosphate compound is an ammonium acid salt, preferably chosen from ammonium phosphate monobasic NH₄H₂PO₄ and ammonium hydrogen phosphate (NH₄)₂HPO₄.

51. Fire-retarding mixture according to claim 35, characterized in that the concentration of ammonium phosphate compound is comprised between 25 and 600 grammes per litre of solution, and preferably is less than or equal to 400 grammes per litre of solution.

52. Fire-retarding mixture according to claim 35, characterized in that the dispersed carbonaceous component has a particle size comprised between 10 nm and 1000 nm, preferably comprised between 10 nm and 600 nm.

53. Process for the production of a mixture comprising an aqueous solution of an ammonium phosphate compound and at least one carbonaceous component dispersed in the aqueous solution, according to claim 35, characterized in that it comprises the following steps:
providing water inside a container;
dispersion of the at least one carbonaceous component and the ammonium phosphate compound inside the container;
solubilization of the ammonium phosphate compound in water;
stirring until the carbonaceous component is uniformly dispersed in the aqueous solution.

54. Process according to claim 53, characterized in that it comprises a further step of heating the aqueous solution with the dispersed carbonaceous component to a temperature greater than or equal to 65° C.

55. Process according to claim 53, characterized in that the ammonium phosphate compound is an ammonium acid salt preferably chosen from ammonium phosphate monobasic NH₄H₂PO₄ and ammonium hydrogen phosphate (NH₄)₂HPO₄.

56. Process according to claim 53, characterized in that it comprises a further step of mixing with a water-based polymeric emulsion or with a additive polymeric dispersion comprising:
a binder consisting of a water-based polymeric emulsion;
titanium dioxide (TiO₂),
lignin;
the water-based polymeric emulsion or the additive polymeric dispersion being added in an amount equal to at least 0.5% by weight of the final mixture.

57. Fabric, characterized in that it comprises at least one layer of fire-retarding mixture according to claim 35.

58. Fabric according to claim 57, characterized in that the mixture is sprayed or spread onto a surface of the fabric.

59. Fabric according to claim 57, characterized in that the layer of fire-retarding mixture has a thickness of at least 0.05 mm, preferably comprised between 0.1 and 3 mm, preferably between 0.1 and 2.5 mm.

60. Fabric according to claim 57, characterized in that it comprises a fire-retarding layer in the form of a polymeric matrix with a carbonaceous component in the dispersed phase, obtained by means of heat treatment, at a temperature greater than 100° C., of a mixture of graphene oxide, in a quantity equal to at least 0.01% and preferably comprised between 0.1% and 2.5% by weight of the mixture.

61. Fabric according to claim 58, wherein the layer of fire-retarding mixture is at least 10% of the weight of the fabric per square metre, preferably between 10% and 70%, more preferably between 25% and 40%, of the weight of the treated fabric per square metre.

62. Method for fire-retarding treatment of a surface comprising a step of applying a layer of a mixture according to claim 35 on the surface.

63. Method according to claim 62, wherein the surface is the rear of a fabric.

64. Method according to claim 62, wherein the mixture is sprayed, spread or applied by means of soaking in a mixture bath.

65. Method according to claim 62, comprising an additional step of heat treatment of the fabric with the mixture applied.

66. Method according to claim 63, wherein a layer of mixture with a thickness of at least 0.1 mm, preferably between 1 and 4 mm, more preferably between 1.5 and 2.5 mm, is applied onto the surface of the fabric.

67. Method according to claim 62, comprising a step of heat treatment of the layer of mixture applied, at a temperature higher than 100° C.

68. Use of a mixture according to claim 35 for the fire-retarding treatment of a fabric.
